(19) United States
(12) Patent Application Publication
(10) Pub. No.: US 2009/0053680 A1
(43) Pub. Date: Feb. 26, 2009

(54) COMPOSITIONS AND METHODS FOR INDUCING SATIETY AND REDUCING CALORIC INTAKE

(76) Inventors: Steven J. Catani, Athens, GA (US); Juan L. Navia, Doylestown, PA (US); Thomas E. Sox, Ambler, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/147,198

(22) Filed: Jun. 26, 2008

Related U.S. Application Data
(60) Provisional application No. 60/947,058, filed on Jun. 29, 2007.

(51) Int. Cl. G09B 19/00

(52) U.S. Cl. 434/127

(57) ABSTRACT

A method is provided for determining the eating restraint behavior of an individual and communicating a recommendation to the individual based on the eating restraint behavior for compositions to consume that effective for the diagnosed eating restraint behavior. Such compositions effective for low rigid restraint eaters include soluble fiber and a multivalent cation.

### FIELD OF THE INVENTION

### CROSS-REFERENCE TO RELATED APPLICATIONS

The present invention is directed to a method of determining the eating restraint behavior of an individual, and providing treatments for reducing food intake or weight based on the determined eating restraint behavior.

### BACKGROUND OF THE INVENTION

Diabetes and obesity are common ailments in the United States and other Western cultures. A study by researchers at RTI International and the Centers for Disease Control estimated that U.S. obesity-attributable medical expenditures reached $75 billion in 2003. Obesity has been shown to promote many chronic diseases, including type 2 diabetes, cardiovascular disease, several types of cancer, and gallbladder disease.

Adequate dietary intake of soluble fiber has been associated with a number of health benefits, including decreased blood cholesterol levels, improved glycemic control, and the induction of satiety and satiation in individuals. Consumers have been resistant to increasing soluble fiber amounts in their diet, however, often due to the negative organoleptic characteristics, such as, sliminess, excessive viscosity, excessive dryness and poor flavor, that are associated with food products that include soluble fiber.

Stable, organoleptically acceptable product that delivers a calcium salt and a greater than normal level of alginate while preventing these two components from reacting during its shelf life and prior to ingesting the product have been previously described. The product can be a cookie or mini bar with a fruit component.

Also needed is a method for determining which individuals are most likely to achieve reduced food intake as a result of consumption of the inventive compositions. This method may be a psychological test to determine their eating restraint behavior. This test may be administered via an internet site or at the physical point of purchase of a product in order to determine whether an individual is particularly likely to obtain a food intake control benefit from the use the inventive compositions disclosed.

Various psychological or psychometric tools are provided for determining the eating behavior of an individual. One preferred tool is the Three-Factor Eating Questionnaire (“TFEQ”), which is a written test that determines three major eating related factors designated as cognitive restraint, disinhibition, and hunger. This test is described in detail in “The Three-Factor Eating Questionnaire to measure dietary restraint, disinhibition, and hunger” by A. J. Stunkard and S. Messick (Journal of Psychosomatic Research 29:71-83 (1985)), which is fully incorporated herein by reference.

One component of this tool, cognitive restraint, is further divided into rigid restraint scale and a flexible restraint scale. Individuals who score high on the rigid restraint scale have been characterized as “all or nothing” dieters. This behavior consists of periods of strong dietary restraint interspersed with episodes of “binge eating” during which excess calories are consumed. Thus, compensatory behavior may occur that counteracts or overwhelms attempts to limit food intake. Individuals with high rigid restraint have been postulated to be less successful in weight loss efforts than individuals who score low on the rigid scale.

The flexible and rigid scales are further described in “Validation of the flexible and rigid control dimensions of dietary restraint”, by J. Westenhoefer, A. J. Stunkard, and V. Pudel (International Journal of Eating Disorders 26:53-64 (1999)), which is fully incorporated herein by reference. Westenhoefer et al. suggested that individuals scoring high on the rigid control scale and low on the flexible control scale may be poor candidates for weight reduction programs, which are largely dependent on reduced food consumption.

Other researchers have postulated that restrained eaters who constantly strive to control their food intake develop anomalous eating patterns and periodic overindulgence (see “Restrained eating”, by C. P. Herman and J. Polivy in (A. J. Stunkard, ed.) Obesity, Saunders (Philadelphia (1980)).

Other recent evidence suggests that individuals with high dietary restraint are more responsive to external cues (see “Cognitive restraint and sensitivity to cues for hunger and satiety”, by J. Ogden and J. Wardle (Physiology and Behavior 47:477-481 (1990)). However, the relationship between rigid control status and success in limiting food intake and reducing weight is certainly not clear. For example, a study by McGuire (“The relationship between restraint and weight and weight-related behaviors among individuals in a community weight gain prevention trial”, by M. T. McGuire, R. W. Jeffrey, S. A. French, and P. J. Hannan, International Journal of Obesity 25:574-580 (2001)), which is fully incorporated herein by reference, did not detect an association between rigid restraint score and weight loss or behavior related to energy balance. Similarly, a report by Williamson (“Association of body mass with dietary restraint and disinhibition”, by D. A. Williamson, et al., Appetite 25:31-41 (1995)), which is fully included herein by reference, did not identify an association between body mass index (BMI) and total, flexible, or rigid restraint status.

It has now been surprisingly found that individuals who are classified as exhibiting “flexible restraint” (a score of less than or equal to two on the TFEQ) are more responsive to reduced food intake after ingesting compositions of the present invention, in comparison to those exhibiting rigid restraint (a score three or greater) on the scale. A method is provided herein for determining the score of an individual on a rigid restraint subscale, and providing a composition of the present invention to those individuals with low scores.

Yet another embodiment of this invention is directed to a method for reducing food intake or weight in an animal, the method comprising, consisting of and/or consisting essentially of administering to an individual a psychometric tool to determine the eating behavior of that individual, determining the eating behavior of that individual, and providing to the individual a product regimen for weight loss that is tailored specifically to the eating behavior of that individual.

### SUMMARY OF THE INVENTION

The present invention surprisingly solves the above needs by providing a method for reducing food intake in an individual, the method comprising, consisting of and/or consisting essentially of determining the eating restraint behavior of the individual, and providing a food intake control program or a weight loss program that is effective for the determined eating restraint behavior.

Another embodiment of the present invention is directed to A method for reducing food intake in an individual, the method comprising, consisting of, and/or consisting essentially of selecting an individual in need of food intake reduction or weight reduction, administering an instrument to the individual to measure the eating restraint behavior, interpreting the results obtained using the instrument to determine the eating restraint behavior of the individual, and providing a food intake control program that is effective for the determined eating restraint behavior.

A further embodiment of the present invention is directed to a method to facilitate weight loss in an individual with low rigid restraint, the method comprising providing a food intake control program that is effective in a person with low rigid restraint.

### BRIEF DESCRIPTION OF DRAWINGS

FIG. 1 is a graph depicting the effects of an embodiment of the present invention on intestinal viscosity.

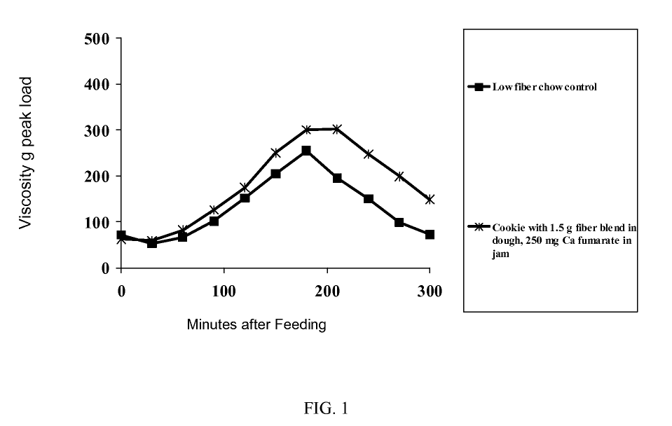

FIG. 2 is a graph depicting the effects of consuming a composition of the present invention in individuals with eating restraint scores of two or less and three or greater.

### DETAILED DESCRIPTION OF THE INVENTION

As used herein, unless indicated otherwise, the terms “alginate,” “pectin,” “carrageenan,” “polygeenan,” or “gellan” refers to all forms (e.g., protonated or salt forms, such as sodium, potassium, and ammonium salt forms and having varying average molecular weight ranges) of the anionic soluble fiber type.

As used herein, unless indicated otherwise, the term “alginic acid” includes not only the material in protonated form but also the related salts of alginate, including but not limited to sodium, potassium, and ammonium alginate.

As used herein, unless indicated otherwise, the term “protected” means that the source has been treated in such a way, as illustrated below, to delay (e.g., until during or after ingestion or until a certain pH range has been reached) reaction of the at least one divalent cation with the anionic soluble fiber as compared to an unprotected divalent cation.

As used herein, the term SE or Satiety Efficiency Index means, unless otherwise defined, caloric reduction in a given meal due to preload divided by the caloric value of the preload. For example, if a person consumes a 1000 calorie lunch without ingesting a preload, but consumes a 900 calorie lunch after ingesting a 200 calorie preload, the preload would have 0.5 or 50% SE. Another example is a person consumes a 1000 calorie lunch without ingesting a preload, but consumes a 800 calorie lunch after ingesting a 100 calorie preload, the preload would have a 2.0 or 200% SE. As can be seen, the greater the SE, the greater the effect of the preload on the next meal.

Unless otherwise defined, all technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

As used herein, a recitation of a range of values is merely intended to serve as a shorthand method of referring individually to each separate value falling within the range, and each separate value is incorporated into the specification as if it were individually recited herein.

The compositions of this invention reduce caloric intake and induce satiety. The inventors believe that this arises from the enhanced viscosity produced by the interactions of soluble cation source and at least one soluble anionic fiber.

### Soluble Anionic Fiber

Any soluble anionic fiber should be acceptable for the purposes of this invention. Suitable soluble anionic fibers include alginate, pectin, gellan, soluble fibers that contain carboxylate substituents, carrageenan, polygeenan, and marine algae-derived polymers that contain sulfate substituents.

Also included within the scope of soluble anionic fibers are other plant derived and synthetic or semisynthetic polymers that contain sufficient carboxylate, sulfate, or other anionic moieties to undergo gelling in the presence of sufficient levels of divalent cation.

At least one source of soluble anionic fiber may be used in these compositions, and the at least one source of soluble anionic fiber may be combined with at least one source of soluble fiber that is uncharged at neutral pH. Thus, in certain cases, two or more anionic soluble fibers types are included, such as, alginate and pectin, alginate and gellan, or pectin and gellan. In other cases, only one type of anionic soluble fiber is used, such as only alginate, only pectin, only carrageenan, or only gellan.

Anionic soluble fibers are commercially available, e.g., from ISP (Wayne, N.J.), TIC Gums, and CP Kelco.

An alginate can be a high guluronic acid alginate. For example, in certain cases, an alginate can exhibit a higher than 1:1 ratio of guluronic to mannuronic acids, such as in the range from about 1.2:1 to about 1.8:1, e.g., about 1.3:1, about 1.4:1, about 1.5:1, about 1.6:1, or about 1.7:1 or any value therebetween. Examples of high guluronic alginates (e.g., having a higher than 1:1 g:m ratios) include Manugel LBA, Manugel GHB, and Manugel DBP, which each have a g:m ratio of about 1.5.

While not being bound by theory, it is believed that high guluronic alginates can cross-link through divalent cations, e.g., calcium ions, to form gels at the low pH regimes in the stomach. High guluronic alginates are also believed to electrostatically associate with pectins and/or gellans at low pHs, leading to gellation. In such cases, it may be useful to delay the introduction of divalent cations until after formation of the mixed alginate/pectin or alginate/gellan gel, as divalent cationic cross-links may stabilize the mixed gel after formation.

In other cases, an alginate can exhibit a ratio of guluronic to mannuronic acids (g:m ratio) of less than about 1:1, e.g., about 0.8:1 to about 0.4:1, such as about 0.5:1, about 0.6:1, or about 0.7:1 or any value therebetween. Keltone LV and Keltone HV are examples of high-mannuronic acids (e.g., having a g:m ratio of less than 1:1) having g:m ratios ranging from about 0.6:1 to about 0.7:1.

Methods for measuring the ratio of guluronic acids to mannuronic acids are known by those having ordinary skill in the art.

An alginate can exhibit any number average molecular weight range, such as a high molecular weight range (about 2.05×10⁵ to about 3×10⁵ Daltons or any value therebetween; examples include Manugel DPB, Keltone HV, and TIC 900 Alginate); a medium molecular weight range (about 1.38×10⁵ to about 2×10⁵ Daltons or any value therebetween; examples include Manugel GHB); or a low molecular weight range (about 2×10⁴ to about 1.35×10⁵ Daltons or any value therebetween; examples include Manugel LBA and Manugel LBB). Number average molecular weights can be determined by those having ordinary skill in the art, e.g., using size exclusion chromatography (SEC) combined with refractive index (RI) and multi-angle laser light scattering (MALLS).

In certain embodiments of an extruded food product, a low molecular weight alginate can be used (e.g., Manugel LBA), while in other cases a mixture of low molecular weight (e.g., Manugel LBA) and high molecular weight (e.g., Manugel DPB, Keltone HV) alginates can be used. In other cases, a mixture of low molecular weight (e.g., Manugel LBA) and medium molecular weight (e.g., Manugel GHB) alginates can be used. In yet other cases, one or more high molecular weight alginates can be used (e.g., Keltone HV, Manugel DPB).

A pectin can be a high-methoxy pectin (e.g., having greater than 50% esterified carboxylates), such as ISP HM70LV and CP Kelco USPL200. A pectin can exhibit any number average molecular weight range, including a low molecular weight range (about 1×10⁵ to about 1.20×10⁵ Daltons, e.g., CP Kelco USPL200), medium molecular weight range (about 1.25×10⁵ to about 1.45×10⁵, e.g., ISP HM70LV), or high molecular weight range (about 1.50×10⁵ to about 1.80×10⁵, e.g., TIC HM Pectin). In certain cases, a high-methoxy pectin can be obtained from pulp, e.g., as a by-product of orange juice processing.

A gellan anionic soluble fiber can also be used. Gellan fibers form strong gels at lower concentrations than alginates and/or pectins, and can cross-link with divalent cation cations. For example, gellan can form gels with sodium, potassium, magnesium and calcium. Gellans for use in the invention include Kelcogel, available commercially from CP Kelco.

Fiber blends as described herein can also be used in the preparation of a solid ingestible composition like a formed food product where the fiber blend is a source of the soluble anionic fiber. A useful fiber blend can include an alginate soluble anionic fiber and a pectin soluble anionic fiber. A ratio of total alginate to total pectin in a blend can be from about 8:1 to about 5:1, or any value therebetween, such as about 7:1, about 6.5:1, about 6.2:1, or about 6.15:1. A ratio of a medium molecular weight alginate to a low molecular weight alginate can range from about 0.65:1 to about 2:1, or any value therebetween.

An alginate soluble anionic fiber in a blend can be a mixture of two or more alginate forms, e.g., a medium and low molecular weight alginate. In certain cases, a ratio of a medium molecular weight alginate to a low molecular weight alginate is about 0.8:1 to about 0.9:1. The high molecular weight alginate has been tested at about 0-2 g. The fiber blend combining low and medium molecular weight alginates with high methoxy pectin has been tested at about 0 to about 3 grams. The preferred range for both would be about 1 to about 2 grams.

The at least one anionic soluble fiber may be treated before, during, or after incorporation into an ingestible composition. For example, the at least one anionic soluble fiber can be processed, e.g., extruded, roll-dried, freeze-dried, dry blended, roll-blended, agglomerated, coated, or spray-dried.

For solid forms, a variety of extruded shapes of food products can be prepared by methods known to those having ordinary skill in the art, e.g., extruding, molding, pressing, wire cutting, and the like. For example, a single or double screw extruder can be used. Typically, a feeder meters in the raw ingredients to a barrel that includes the screw(s). The screw(s) conveys the raw material through the die that shapes the final product. Extrusion can take place under high temperatures and pressures or can be a non-cooking, forming process. Extruders are commercially available, e.g., from Buhler, Germany. Extrusion can be cold or hot extrusion.

Other processing methods are known to those having skilled in the art.

The amount of the at least one anionic soluble fiber included can vary, and will depend on the type of ingestible composition and the type of anionic soluble fiber used. For example, typically a solid ingestible composition will include from about 0.5 g to about 10 g total soluble anionic fiber per serving or any value therebetween. A preferred range of fiber intake in the compositions of this invention is about 0.25 g to about 5 g per serving, more preferably about 0.5 to about 3 g per serving, and most preferably about 1.0 to about 2.0 g per serving. In certain cases, an extruded food product can include an anionic soluble fiber at a total amount from about 22% to about 40% by weight of the extruded product or any value therebetween. In other cases, an extruded food product can include an anionic soluble fiber in a total amount of from about 4% to about 15% or any value therebetween, such as when only gellan is used. In yet other cases, an extruded food product can include an anionic soluble fiber at a total amount of from about 18% to about 25% by weight, for example, when combinations of gellan and alginate or gellan and pectin are used.

In addition to the at least one anionic soluble fiber, a solid ingestible composition can include ingredients that may be treated in a similar manner as the at least one anionic soluble fiber. For example, such ingredient can be co-extruded with the anionic soluble fiber, co-processed with the anionic soluble fiber, or co-spray-dried with the anionic soluble fiber. Such treatment can help to reduce sliminess of the ingestible composition in the mouth and to aid in hydration and gellation of the fibers in the stomach and/or small intestine. Without being bound by any theory, it is believed that co-treatment of the anionic soluble fiber(s) with such ingredient prevents early gellation and hydration of the fibers in the mouth, leading to sliminess and unpalatability. In addition, co-treatment may delay hydration and subsequent gellation of the anionic soluble fibers (either with other anionic soluble fibers or with divalent cations) until the ingestible composition reaches the stomach and/or small intestine, providing for the induction of satiety and/or satiation.

Additional ingredients can be hydrophilic in nature, such as starch, protein, maltodextrin, and inulin. Other additional ingredients can be insoluble in water (e.g., cocoa solids, corn fiber) and/or fat soluble (vegetable oil), or can be flavor modifiers, such as, sucralose. For example, an extruded food product can include from about 5 to about 80% of a cereal ingredient, such as about 40% to about 68% of a cereal ingredient. A cereal ingredient can be rice, corn, wheat, sorghum, oat, or barley grains, flours, or meals. Thus, an extruded food product can include about 40% to about 50%, about 50% to about 58%, about 52% to about 57%, or about 52%, about 53%, about 54%, about 55%, about 56%, or about 56.5% of a cereal ingredient. In one embodiment, about 56.5% of rice flour is included.

An ingestible composition can also include a protein source. A protein source can be included in the composition or in an extruded food product. For example, an extruded food product can include a protein source at about 2% to about 20% by weight, such as about 3% to about 8%, about 3% to about 5%, about 4% to about 7%, about 4% to about 6%, about 5% to about 7%, about 5% to about 15%, about 10% to about 18%, about 15% to about 20%, or about 8% to about 18% by weight. A protein can be any known to those having ordinary skill in the art, e.g., rice, milk, egg, wheat, whey, soy, gluten, or soy flour. In some cases, a protein source can be a concentrate or isolate form.

### Soluble Source

The compositions and associated methods of this invention include a source of at least one soluble cation source in an amount sufficient to cause an increase in viscosity of the anionic soluble fiber. A source of at least one soluble cation may be incorporated into an ingestible composition provided herein, or can consumed as a separate food article either before, after, or simultaneously with an ingestible composition.

Any soluble cation maybe used in the present invention. Cations useful in this invention include, calcium, magnesium, aluminum, manganese, iron, nickel, copper, zinc, strontium, barium, bismuth, chromium, vanadium, lanthanum, their salts and mixtures thereof. Soluble cation sources may be organic acid salts that include formate, fumarate, acetate, propionate, butyrate, caprylate, valerate, lactate, citrate, malate and gluconate. Also included are highly soluble inorganic salts such as chlorides or other halide salts.

In certain compositions, at least one soluble cation source is used with certain anionic soluble fibers, depending on the composition and gel strength desired. For example, for ingestible alginate compositions, calcium may be used to promote gellation. For gellan compositions, one or more of calcium and magnesium may be used.

The at least one soluble cation source can be unable to, or be limited in its ability to, react with the at least one anionic soluble fiber in the ingestible composition until during or after ingestion. For example, physical separation of the at least one soluble cation source from the at least one anionic soluble fiber, e.g., as a separate food article or in a separate matrix of the ingestible composition from the at least one anionic soluble fiber, can be used to limit at least one soluble cation sources ability to react. In other cases, the at least one soluble cation source is limited in its ability to react with the at least one anionic soluble fiber by protecting the source of at least one soluble cation source until during or after ingestion. Thus, the at least one soluble cation source, such as, a protected soluble cation source can be included in the ingestible composition or can be included as a separate food article composition, e.g., for separate ingestion either before, during, or after ingestion of an ingestible composition.

Typically, a separate food article containing the at least one soluble cation source would be consumed in an about four hour time window flanking the ingestion of an ingestible composition containing the at least one anionic soluble fiber. In certain cases, the window may be about three hours, or about two hours, or about one hour. In other cases, the separate food article may be consumed immediately before or immediately after ingestion of an ingestible composition, e.g., within about fifteen minutes, such as within about 10 mins., about 5 mins., or about 2 mins. In other cases, a separate food article containing at least one soluble cation source can be ingested simultaneously with an ingestible composition containing the at least one soluble anionic fiber, e.g., a snack chip composition where some chips include at least one soluble cation and some chips include the at least one soluble anionic fiber.

In one embodiment, at least one soluble cation source can be included in an ingestible composition in a different food matrix from a matrix containing an anionic soluble fiber. For example, a source of at least one soluble cation source, such as a soluble calcium salt, can be included in a separate matrix of a solid ingestible composition from the matrix containing the at least one soluble anionic fibers. Thus, means for physical separation of an anionic soluble fiber (e.g., within a snack bar or other extruded food product) from a source of at least one soluble cation source are also contemplated, such as by including the source of at least one soluble cation source in a matrix such as a frosting, water and fat based icing, coating, decorative topping, drizzle, chip, chunk, swirl, filling, or interior layer. In one embodiment, the at least one soluble cation source, such as, a protected soluble cation source, can be included in a snack bar matrix that also contains an extruded crispy matrix that contains the anionic soluble fiber. In such a case, the at least one soluble cation source is in a separate matrix than the extruded crispy matrix containing the anionic soluble fiber. In another embodiment, the at least one soluble cation source can be included in a gel layer or phase, e.g., a jelly or jam.

One soluble cation source is divalent cation salts. Typically, a divalent cation salt can be selected from the following salts: citrate, tartrate, malate, formate, lactate, gluconate, phosphate, carbonate, sulfate, chloride, acetate, proprionate, butyrate, caprylate, valerate, fumarate, adipate, and succinate. In certain cases, a divalent cation salt is a calcium salt. A calcium salt can have a solubility of >1% w/vol in water at pH 7 at 20° C. A calcium salt can be, without limitation, calcium citrate, calcium tartrate, calcium malate, calcium lactate, calcium gluconate, dicalcium phosphate dihydrate, anhydrous calcium diphosphate, dicalcium phosphate anhydrous, calcium carbonate, calcium sulfate dihydrate, calcium sulfate anhydrous, calcium chloride, calcium acetate monohydrate, monocalcium phosphate monohydrate, and monocalcium phosphate anhydrous.

The source of at least one soluble cation source can be a protected source.

A number of methods can be used to protect at least one soluble cation source. For example, microparticles or nanoparticles having double or multiple emulsions, such as water/oil/water (“w/o/w”) or oil/water/oil (“o/w/o”) emulsions, of at least one soluble cation source and an anionic soluble fiber can be used. In one embodiment, a calcium alginate microparticle or nanoparticle is used. For example, a calcium chloride solution can be emulsified in oil, which emulsion can then be dispersed in a continuous water phase containing the anionic alginate soluble fiber. When the emulsion breaks in the stomach, the calcium can react with the alginate to form a gel.

A microparticle can have a size from about 1 to about 15 μM (e.g., about 5 to about 10 μM, or about 3 to about 8 μM). A nanoparticle can have a size of about 11 to about 85 nm (e.g., about 15 to about 50 nm, about 30 to about 80 nm, or about 50 to about 75 nm). The preparation of multiple or double emulsions, including the choice of surfactants and lipids, is known to those having ordinary skill in the art.

In another embodiment, nanoparticles of calcium alginate are formed by preparing nanodroplet w/o microemulsions of CaCl₂ in a solvent and nanodroplet w/o microemulsions of alginate in the same solvent. When the two microemulsions are mixed, nanoparticles of calcium alginate are formed. The particles can be collected and dispersed, e.g., in a liquid ingestible composition. As the particle size is small (<100 nm), the particles stay dispersed (e.g., by Brownian motion), or can be stabilized with a food grade surfactant. Upon ingestion, the particles aggregate and gel.

In other embodiments, a liposome containing a source of at least one divalent cation can be included in an ingestible composition. For example, a calcium-containing liposome can be used. The preparation of liposomes containing divalent cations is well known to those having ordinary skill in the art; see ACS Symposium Series, 1998 709:203-211; Chem. Mater. 1998 (109-116). Cochelates can also be used, e.g., as described in U.S. Pat. No. 6,592,894 and U.S. Pat. No. 6,153,217. The creation of cochelates using divalent cations such as calcium can protect the divalent cations from reacting with the anionic soluble fiber within the aqueous phase of an ingestible composition, e.g., by wrapping the divalent cations in a hydrophobic lipid layer, thus delaying reaction with the fiber until digestion of the protective lipids in the stomach and/or small intestine via the action of lipases.

In certain cases, a soluble cation source containing carbohydrate glass can be used, such as a calcium containing carbohydrate glass. A carbohydrate glass can be formed from any carbohydrate such as, without limitation, sucrose, trehalose, inulin, maltodextrin, corn syrup, fructose, dextrose, and other mono-, di-, or oligo-saccharides using methods known to those having ordinary skill in the art; see, e.g., WO 02/05667. A carbohydrate glass can be used, e.g., in a coating or within a food matrix.

### Ingestible Compositions

Compositions of the present invention can be in any form, liquid or solid. Liquids can be beverages, including shake, liquado, and smoothie. Liquids can be from low to high viscosity.

Solid forms can extruded or not. Solid forms may include bread, cracker, bar, mini-bars, cookie, confectioneries, e.g., nougats, toffees, fudge, caramels, hard candy enrobed soft core, muffins, cookies, brownies, cereals, chips, snack foods, bagels, chews, crispies, and nougats, pudding, jelly, and jam. Solids can have densities from low to high.

### Fluid

Fluid ingestible compositions can be useful for, among other things, aiding in weight loss programs, e.g., as meal replacement beverages or diet drinks. Fluid ingestible compositions can provide from about 0.5 g to about 10 g of anionic soluble fiber per serving, or any value therebetween. For example, in certain cases, about 1 g, 2 g, 3 g, 4 g, 5 g, 6 g, 7 g, 8 g, or 9 g of at least one anionic soluble fiber are provided per serving.

A fluid ingestible composition may include an alginate anionic soluble fiber and/or a pectin anionic soluble fiber. In certain cases, an alginate anionic soluble fiber and a pectin anionic soluble fiber are used. A fiber blend as described herein can be used to provide the alginate anionic soluble fiber and/or the pectin anionic soluble fiber. An alginate and pectin can be any type and in any form, as described previously. For example, an alginate can be a high, medium, or low molecular weight range alginate, and a pectin can be a high-methoxy pectin. Also as indicated previously, two or more alginate forms can be used, such as a high molecular weight and a low molecular weight alginate, or two high molecular weight alginates, or two low molecular weight alginates, or a low and a medium molecular weight alginate, etc. For example, Manugel GHB alginate and/or Manugel LBA alginate can be used. In other cases, Manugel DPB can be used. Genu Pectin, USPL200 (a high-methoxy pectin) can be used as a pectin. In certain cases, potassium salt forms of an anionic soluble fiber can be used, e.g., to reduce the sodium content of an ingestible composition.

A fluid ingestible composition includes alginate and/or pectin in a total amount of about 1.0% to about 5% by weight, or any value therebetween, e.g., about 1.25% to about 1.9%; about 1.4% to about 1.8%; about 1.0% to about 2.2%, about 2.0% to about 4.0%, about 3.0%, about 4.0%, about 2.0%, about 1.5%, or about 1.5% to about 1.7%. Such percentages of total alginate and pectin can yield about 2 g to about 8 g of fiber per 8 oz. serving, e.g., about 3 g, about 4 g, about 5 g, about 6 g, or about 7 g fiber per 8 oz. serving. In other cases, about 4 g to about 8 g of fiber (e.g., about 5 g, about 6 g, or about 7 g) per 12 oz. serving can be targeted. In some embodiments, about 1.7% fiber by weight of a fluid ingestible composition is targeted.

In some cases, a fluid ingestible composition includes only alginate as a soluble anionic fiber. In other cases, alginate and pectin are used. A ratio of alginate to pectin (e.g., total alginate to total pectin) in a fluid ingestible composition can range from about 8:1 to about 1:8, and any ratio therebetween (e.g., alginate:pectin can be in a ratio of about 1:1, about 1.2:1, about 1.3:1, about 1.4:1, about 1.5:1, about 1.6:1, about 1.62:1, about 1.7:1, about 1.8:1, about 1.9:1, about 2:1, about 3:1, about 4:1, about 5:1, about 5.3:1, about 5.6:1, about 5.7:1, about 5.8:1, about 5.9:1, about 6:1, about 6.1:1, about 6.5:1, about 7:1, about 7.5:1, about 7.8:1, about 2:3, about 1:4, or about 0.88:1). In cases where alginate and pectin are in a ratio of about 0.5:1 to about 2:1, it is believed that pectin and alginate electrostatically associate with one another to gel in the absence of divalent cations; thus, while not being bound by theory, it may be useful to delay the introduction of cations until after such gel formation. In other cases, where the ratio of alginate to pectin is in the range from about 3:1 to about 8:1, it may be useful to include a soluble cation source such as a calcium source (e.g., to crosslink the excess alginate) to aid gel formation in the stomach. In these cases, the inventors believe, while not being bound by any theory, that the lower amount of pectin protects the alginate from precipitating as alginate at the low pHs of the stomach environment, while the soluble cation source cross-links and stabilizes the gels formed.

A liquid ingestible composition can have a pH from about 3.9 to about 4.5, e.g., about 4.0 to about 4.3 or about 4.1 to about 4.2. At these pHs, it is believed that the liquid ingestible compositions are above the pKas of the alginate and pectin acidic subunits, minimizing precipitation, separation, and viscosity of the solutions. In some cases, malic, phosphoric, and citric acids can be used to acidify the compositions. In some cases, a liquid ingestible composition can have a pH of from about 5 to about 7.5. Such liquid ingestible compositions can use pH buffers known to those having ordinary skill in the art.

Sweeteners for use in a fluid ingestible composition can vary according to the use of the composition. For diet beverages, low glycemic sweeteners may be preferred, including trehalose, isomaltulose, aspartame, saccharine, and sucralose. Sucralose can be used alone in certain formulations. The choice of sweetener will impact the overall caloric content of a liquid ingestible composition. In certain cases, liquid ingestible compositions can be targeted to have 40 calories/12 oz serving.

A fluid ingestible composition can demonstrate gel strengths of about 20 to about 250 grams force (e.g., about 60 to about 240, about 150 to about 240, about 20 to 30, about 20 to about 55, about 50 to 200; about 100 to 200; and about 175 to 240), as measured in a static gel strength assay. Gel strengths can be measured in the presence and absence of a soluble cation source, such as a calcium source.

A fluid ingestible composition can exhibit a viscosity in the range of from about 15 to about 100 cPs, or any value therebetween, at a shear rate of about 10^{-s}, e.g., about 17 to about 24; about 20 to about 25; about 50 to 100, about 25 to 75, about 20 to 80, or about 15 to about 20 cPs. Viscosity can be measured by those skilled in the art, e.g., by measuring flow curves of solutions with increasing shear rate using a double gap concentric cyclinder fixture (e.g., with a Parr Physica Rheometer).

A fluid ingestible composition can include a cation sequestrant, e.g., to prevent premature gellation of the anionic soluble fibers. A divalent cation sequestrant can be selected from EDTA and its salts, EGTA and its salts, sodium citrate, sodium hexametaphosphate, sodium acid pyrophosphate, trisodium phosphate anhydrous, tetrasodium pyrophosphate, sodium tripolyphosphate, disodium phosphate, sodium carbonate, and potassium citrate. A cation sequestrant can be from about 0.001% to about 0.3% by weight of the ingestible composition. Thus, for example, EDTA can be used at about 0.0015% to about 0.002% by weight of the ingestible composition and sodium citrate at about 0.230% to about 0.260% (e.g., 0.250%) by weight of the ingestible composition.

A fluid ingestible composition can include a juice or juice concentrate and optional flavorants and/or colorants. Juices for use include fruit juices such as apple, grape, raspberry, blueberry, cherry, pear, orange, melon, plum, lemon, lime, kiwi, passionfruit, blackberry, peach, mango, guava, pineapple, grapefruit, and others known to those skilled in the art. Vegetable juices for use include tomato, spinach, wheatgrass, cucumber, carrot, peppers, beet, and others known to those skilled in the art.

The brix of the juice or juice concentrate can be in the range of from about 15 to about 85 degrees, such as about 25 to about 50 degrees, about 40 to about 50 degrees, about 15 to about 30 degrees, about 65 to about 75 degrees, or about 70 degrees. A liquid ingestible composition can have a final brix of about 2 to about 25 degrees, e.g., about 5, about 10, about 12, about 15, about 20, about 2.5, about 3, about 3.5, about 3.8, about 4, or about 4.5.

Flavorants can be included depending on the desired final flavor, and include flavors such as kiwi, passionfruit, pineapple, coconut, lime, creamy shake, peach, pink grapefruit, peach grapefruit, pina colada, grape, banana, chocolate, vanilla, cinnamon, apple, orange, lemon, cherry, berry, blueberry, blackberry, apple, strawberry, raspberry, melon(s), coffee, and others, available from David Michael, Givaudan, Duckworth, and other sources.

Colorants can also be included depending on the final color to be achieved, in amounts quantum satis that can be determined by one having ordinary skill in the art.

Rapid gelling occurs when soluble anionic fibers, such as alginate or pectin, are mixed with soluble calcium sources, particularly the calcium salts of organic acids such as lactic or citric acid. For beverage products, this reactivity prevents the administration of soluble anionic fiber and a highly soluble calcium source in the same beverage. In the present invention, this problem is overcome by administering the soluble anionic fiber and the soluble calcium source in different product components.

### Solids

At least one anionic soluble fiber and/or at least one soluble cation source can be present in a solid ingestible composition in any form or in any mixtures of forms. A form can be a processed, unprocessed, or both. Processed forms include extruded forms, spray-dried forms, roll-dried forms, or dry-blended forms. For example, a snack bar can include at least anionic soluble anionic fiber present as an extruded food product (e.g., a crispy), at least one soluble cation source in an unextruded form (e.g., as part of the bar), or both.

An extruded food product can be cold- or hot-extruded and can assume any type of extruded form, including without limitation, a bar, cookie, bagel, crispy, puff, curl, crunch, ball, flake, square, nugget, and snack chip. In some cases, an extruded food product is in bar form, such as a snack bar or granola bar. In some cases, an extruded food product is in cookie form. In other cases, an extruded food product is in a form such as a crispy, puff, flake, curl, ball, crunch, nugget, chip, square, chip, or nugget. Such extruded food products can be eaten as is, e.g., cookies, bars, chips, and crispies (as a breakfast cereal) or can be incorporated into a solid ingestible composition, e.g., crispies incorporated into snack bars.

A solid form may also be a lollipop or a lolly that is made of hardened, flavored sugar mounted on a stick and intended for sucking or licking. One form of lollipop has a soft-chewy filling in the center of the hardened sugar. The soft filling may be a gum, fudge, toffee, caramel, jam, jelly or any other soft-chewy filling known in the art. The at least one divalent cation may be in the soft-chewy center or the harnend sugar. Likewise, at least fiber may be in the soft-chewy center or the harnend sugar. A hard candy filled with a soft-chewy center is another embodiment of the present invention. This embodiment is similar to the lollipop, except it is not mounted on a stick. The soft-chewy filling may be in the center or swirled or layered with the hard sugar confection.

A cookie or mini-bar can include at least one soluble anionic fiber in an unformed form or in a formed (e.g., extruded) form. A snack chip can include at least one soluble anionic fiber in extruded form or in spray-dried form, or both, e.g., an extruded anionic soluble fiber-containing chip having at least one anionic soluble fiber spray-dried on the chip.

A solid ingestible composition can include optional additions such as, frostings, icings, coatings, toppings, drizzles, chips, chunks, swirls, or layers. Such optional additions can include at least one soluble cation source, at least one anionic soluble fiber, or both.

Solid ingestible compositions can provide any amount from about 0.5 g to about 10 g total anionic soluble fiber per serving, e.g., about 0.5 g to about 5 g, about 1 g to about 6 g, about 3 g to about 7 g, about 5 g to about 9 g, or about 4 g to about 6 g. For example, in some cases, about 1 g, about 2 g, about 3 g, about 4 g, about 5 g, about 6 g, about 7 g, about 8 g, or about 9 g of anionic soluble fiber per serving can be provided.

A solid ingestible composition can include at least one anionic soluble fiber at a total weight percent of the ingestible composition of from about 4% to about 50% or any value therebetween. For example, a solid ingestible composition can include at least one anionic soluble fiber of from about 4% to about 10% by weight; or about 5% to about 15% by weight; or about 10% to about 20% by weight; or about 20% to about 30% by weight; or about 30% to about 40% by weight; or about 40% to about 50% by weight.

An extruded food product can be from about 0% to 100% by weight of an ingestible composition, or any value therebetween (about 1% to about 5%; about 5% to about 10%; about 10% to about 20%; about 20% to about 40%; about 30% to about 42%; about 35% to about 41%; about 37% to about 42%; about 42% to about 46%; about 30% to about 35%; about 40% to about 50%; about 50% to about 60%; about 60% to about 70%; about 70% to about 80%; about 80% to about 90%; about 90% to about 95%; about 98%; or about 99%). For example, an extruded bar, cookie, or chip can be about 80% to about 100% by weight of an ingestible composition or any value therebetween.

Alternatively, an ingestible composition can include about 30% to about 55% by weight of an extruded food product or any value therebetween, e.g., about 32%, about 33%, about 34%, about 35%, about 36%, about 37%, 3 about 8%, about 39%, about 40%, about 42%, about 45%, about 48%, about 50%, about 52%, or about 54% by weight of an extruded food product. For example, a snack bar composition can include extruded crispies in an amount of from about 32% to about 46% by weight of the snack bar.

### Crispies

An extruded food product, e.g., for inclusion in an ingestible composition, can be a crispy. For example, crispies that include one or more alginates and/or pectins in a total amount of about 30% to about 35% by weight can be included in a snack bar in an amount of about 32% to about 45% by weight of the snack bar. Crispies can be prepared using a fiber blend as described herein. Crispies can also include, among other things, about 52% to about 58% by weight of one or more of a rice flour, corn meal, and/or corn cone; and about 2% to about 10% of a protein isolate. Crispies can be prepared using methods known to those having ordinary skill in the art, including cold and hot extrusion techniques.

An ingestible composition or formed food product can include one or more of the following: cocoa, including flavonols, and oils derived from animal or vegetable sources, e.g., soybean oil, canola oil, corn oil, safflower oil, sunflower oil, etc. For example, a formed food product can include cocoa or oils in an amount of about 3% to about 10% (e.g., about 3% to about 6%, about 4% to about 6%, about 5%, about 6%, about 7%, or about 4% to about 8%) by weight of the food product.

One embodiment of the present invention is a stable two phase product having at least one soluble anionic fiber and at least one soluble cation source in the same product, but formulated so that the soluble anionic fiber and cation source do not react during processing or prior to ingestion, but react following ingestion as a standard cation-anion reaction. One product design includes a jam phase center, e.g., fluid phase, and a crisp baked phase, e.g., solid phase, outside the jam phase. One embodiment places the soluble anionic fiber in the jam phase and places the soluble cation source in the baked phase.

Another embodiment of the present invention addresses this issue, adding of the soluble anionic fiber to the baked dough phase and the divalent cation to the jam phase, which provides a cookie that reduces the water activity of the fiber-containing phase which restricted fiber so that it was prevented from reacting with the divalent cation. The placement of the divalent cation into a postbake, medium water activity filler, e.g., the fluid phase, allowed the cation to be formulated in the product with an acceptable organoleptic profile and an inability to react with fiber even if minor migration occurs.

The water activities of both components can be further adjusted to deliver a product with not only restrictive reaction in place but acceptable eating qualities and the right characteristics needed to for ease of manufacturing.

Types of salts tested include calcium fumarate, tricalcium phosphate, dicalcium phosphate dihydrate and calcium carbonate. The gram weight tested will vary depending on the salt type due to its characteristic calcium load. The piece weight of the product under discussion has been about 13 to about 20 g, with each piece delivering from about 50 to about 75 kcal.

BENEFAT® is a family of triglyceride blends made from the short and long chain fatty acids commonly present in the diet. It is the uniqueness of these fatty acids that contribute to the range's reduced calorie claim. BENEFAT® products are designed to replace conventional fats and oils in dairy, confectionery and bakery products, giving full functionality with significantly reduced energy and fat content. BENEFAT® is the Danisco trade name for SALATRIM, the abbreviation for short and long-chain triglyceride molecules. The short-chain acids (C₂-C₄) may be acetic, propionic, butyric or a combination of all three, while the long-chain fatty acid (C₁₆-C-₂₂) is predominantly stearic and derived from fully hardened vegetable oil. Unlike other saturated fatty acids, stearic acid has a neutral effect on blood cholesterol. BENEFAT® is also free of trans fatty acids and highly resistant to oxidation. Compared to the 9 calories per gram of traditional fat, BENEFAT® contains just 5 calories per gram (US regulation) or 6 calories per gram (EU regulation), at the same time giving foods a similar creamy taste, texture, and mouthfeel as full-fat products. Metabolisation upon consumption occurs in much the same way as with other food components.

A preferred product features include about 500 to about 1500 mg of alginate are present, the cation is calcium, wherein about 50 to about 500 mg of elemental calcium are delivered. The product has low calories between about 50 to about 100 calories and is a cookie with a jam filling.

The soluble anionic fiber can be provided in one beverage component, and a soluble cation source can be provided in a second beverage component. The first component and the second component are provided separately to the user in a bottle or cup, and the user consumes the two components concurrently or sequentially.

Alternately, the soluble anionic fiber may be delivered in a beverage component and a soluble cation source may be provided separately in a solid edible component. The liquid fiber component and the solid soluble cation source component are consumed concurrently or sequentially.

The soluble anionic fiber component may also be provided in a solid edible component, and the soluble cation source may be provided separately in a liquid component. The liquid soluble cation source component and the solid fiber component are consumed concurrently or sequentially.

The soluble anionic fiber component and the soluble cation source can both be provided in solid edible components. The components can be provided in the form of separate items for consumption, or both components can be combined in a single solid form for consumption. This single solid form may contain the soluble anionic fiber in one phase, such as, a layer or filling, and the soluble cation source can be provided in a separate phase, such as a layer or filling. Alternatively, the fiber and soluble cation source may be intimately mixed in the same solid form.

The ingestible composition of the present invention can be provided in any package, such as enclosed in a wrapper or included in a container. An ingestible composition can be included in an article of manufacture. An article of manufacture that includes an ingestible composition described herein can include auxiliary items such as straws, napkins, labels, packaging, utensils, etc.

An article of manufacture can include a source of at least one soluble cation source. For example, the soluble cation source can be provided as a liquid, e.g., as a beverage to be consumed before, during, or after ingestion of the ingestible composition. In other cases, at least one soluble cation source can be provided in a solid or gel form. For example, a source of at least one divalent cation can be provided in, e.g., a jelly, jam, dip, swirl, filling, or pudding, to be eaten before, during, or after ingestion of the ingestible composition. Thus, in some embodiments, an article of manufacture that includes a cookie or bar solid ingestible composition can also include a dip comprising a source of at least one soluble cation source, e.g., into which to dip the cookie or bar solid ingestible composition.

Also provided are articles of manufacture that include a liquid ingestible composition. For example, a liquid ingestible composition can be provided in a container. Supplementary items such as straws, packaging, labels, etc. can also be included. Alternatively, the soluble anionic fiber may be included in a beverage and the soluble cation source may be provided inside, outside or both of a straw or stirring stick. In some cases, at least one soluble cation source, as described below, can be included in an article of manufacture. For example, an article of manufacture can include a liquid ingestible composition in one container, and a soluble cation source in another container. Two or more containers may be attached to one another.

### Methods of Reducing Caloric Consumption

An anionic soluble fiber (such as alginate and pectin) is orally administered concurrently with a soluble cation source, such as, a water-soluble calcium salt, to reduce caloric intake. Continued use of these compositions by individuals in need of weight loss will result in a cumulative decrease in caloric consumption, which will result in weight loss or diminished weight gain. Although not wishing to be bound by theory, the inventors hypothesize that the cation source cross link the carboxylate groups on the fiber molecules, resulting in the formation of highly viscous or gelled materials. This gelling effect increases the viscosity of the gastric and intestinal contents, slowing gastric emptying, and also slowing the rate of macro-nutrient, e.g., glucose, amino acids, fatty acids, and the like, absorption. These physiological effects prolong the period of nutrient absorption after a meal, and therefore prolong the period during which the individual experiences an absence of hunger. The increased viscosity of the gastrointestinal contents, as a result of the slowed nutrient absorption, also causes a distal shift in the location of nutrient absorption. This distal shift in absorption may trigger the so-called “ileal brake”, and the distal shift may also cause in increase in the production of satiety hormones such as GLP-1 and PYY.

Provided herein are methods employing the ingestible compositions described herein. For example, a method of inducing satiety and/or satiation in an animal is provided. The method can include orally administering an ingestible composition to an animal. An animal can be any animal, including a human, monkey, mouse, rat, snake, cat, dog, pig, cow, sheep, bird or horse. Oral administration can include providing the ingestible combination either alone or in combination with other meal items. Oral administration can include co-administering, either before, after, or during administration of the ingestible composition, a cation source, such as calcium or a sequestered source of calcium, as described herein. At least one soluble cation source can be administered within about a four hour time window flanking the administration of the ingestible composition. For example, a soluble calcium source such as a solution of calcium lactate, can be administered to an animal immediately after the animal has ingested a liquid ingestible composition as provided herein. Satiety and/or satiation can be evaluated using consumer surveys (e.g., for humans) that can demonstrate a statistically significant measure of increased satiation and/or satiety. Alternatively, data from paired animal sets showing a statistically significant reduction in total caloric intake or food intake in the animals administered the ingestible compositions can be used as a measure of facilitating satiety and/or satiation.

As indicated previously, the ingestible compositions provide herein can hydrate and gel in the stomach and/or small intestine, leading to increased viscosity in the stomach and/or small intestine after ingestion. Accordingly, provided herein are methods for increasing the viscosity of stomach and/or small intestine contents, which include administering an ingestible composition to an animal. An animal can be any animal, as described above, and administration can be as described previously. Viscosity of stomach contents can be measured by any method known to those having ordinary skill in the art, including endoscopic techniques, imaging techniques (e.g., MRI), or in vivo or ex vivo viscosity measurements in e.g., control and treated animals.

Also provided are methods for promoting weight loss by administering an ingestible composition as provided herein to an animal. Administration can be as described previously. The amount and duration of such administration will depend on the individual's weight loss needs and health status, and can be evaluated by those having ordinary skill in the art. The animal's weight loss can be measured over time to determine if weight loss is occurring. Weight loss can be compared to a control animal not administered the ingestible composition.

### Methods of Enhancing Weight Loss or Maintenance in Flexible Restraint People

An individual in need of reduced caloric intake or weight loss is supplied with promotional materials, such as, printed brochures, newspaper or magazine advertising, or internet-based information. Included in these materials, or linked to these materials (such as by internet link, or reference to an internet website), is an instrument, e.g., TFEQ, for measuring the eating restraint behavior of an individual. An individual completes the instrument, and thereby determines his or her eating restraint behavior. If the individual's rigid restraint score is less than or equal to two, the individual receives a recommendation to obtain or purchase a product that is particularly effective in reducing food consumption for this type of restraint. The product provided may include two beverage components, with one beverage component containing alginic acid and the second beverage component containing a multivalent cation, e.g., calcium or other compositions contemplated herein.

As described above, use of the TFEQ tool and modifications to it for determining eating restraint behavior of an individual are contemplated herein. Different instruments to achieve the eating restraint behavior are additionally contemplated. Examples of such tools are provided in “Anxiety, restraint, and eating behavior” by C. P Herman and J. Polivy (Journal of Abnormal Psychology 84:66-72 (1975)), which is incorporated fully herein by reference.

The tool for determining eating restraint behavior may be administered to an individual in need thereof in many different locations and by numerous methods. Locations include a doctor's office, other healthcare professional's office, a weight loss center, health or fitness club, or other location that is assisting the individual in monitoring food intake or weight loss efforts of the individual. The tool may be administered to the individual in need thereof in a paper form, by electronic means, including using a computer screen, a television screen, a hand-held electronic device, or a cell phone, or other electronic devices as input, output and/or processing devices.

Also contemplated is the administration of the tool as part of the individual's purchase decision process for a product, particularly at or in proximity to the point of sale of the product. This includes a product label containing a form of the tool or it is provided as a portion of the product; e.g., the individual reads the label at the point of potential sale, diagnoses their own eating restraint behavior by reviewing the answers to the questions on the label using an answer key, and then make a decision to purchase the product if their eating restraint score indicates that the product is likely to improve their success in efforts to decrease caloric intake or reduce weight. It is further contemplated that the point of sale consumer interaction, including both the product package and the surrounding shelf space, may include various aids for making this diagnosis, including comparator cards, charts, or wheel mechanisms for simplifying the process, and that these aids will provide additional versions of the psychometric tool.

The propensity to compensate for lower caloric intake at one meal by overconsuming at a subsequent meal makes it difficult for individuals who are overweight or obese to loose weight by restricting their caloric intake. The compositions described herein assist individuals who exhibit flexible restraint to reduce their daily caloric intake at each meal without subsequent compensation.

The following examples are representative of the invention, and are not intended to be limiting to the scope of the invention.

### EXAMPLES

### Example 1

A study to evaluate the effects of soluble fiber and soluble calcium on food intake was performed by the following procedure.

The study enrolled premenopausal non-smoking overweight or obese women (body mass index between 25 and 35 kg/square meter) selected without regard to racial or ethnic background between 20 and 40 years of age. The TFEQ, see Stunkard and Messick above, was administered to each subject.

The study was a within-subjects design with 30 participants completing three one-week treatment periods, with a washout period of one week between treatment periods. Treatment order was counterbalanced to have five subjects randomly assigned to each of six possible treatment sequences. Subjects in each treatment period consumed a test beverage [WHAT SIZE?] at breakfast and after lunch (mid-afternoon). In one treatment period, subjects consumed a placebo beverage without fiber. In two treatment periods, the test beverage contained a blend of soluble fibers of one of the following compositions:

| | 2.8 g Fiber | 1.0 g Fiber | Placebo |
|---|---|---|---|
| Ingredient | % | % | % |
| Water | 95.470 | 96.400 | 97.010 |
| Trisodium citrate dihydrate | 0.250 | 0.250 | 0.250 |
| LBA alginate (ISP) | 0.640 | 0.210 | 0.000 |
| GHB alginate (ISP) | 0.550 | 0.180 | 0.000 |
| USP L200 pectin (Kelco) | 0.200 | 0.066 | 0.000 |
| Apple juice concentrate | 2.300 | 2.300 | 2.300 |
| EDTA | 0.002 | 0.002 | 0.002 |
| Sucralose | 0.011 | 0.011 | 0.011 |
| Malic acid, granular | 0.200 | 0.200 | 0.200 |
| Red 40, 10% solution | 0.001 | 0.001 | 0.001 |
| Flavor | 0.380 | 0.380 | 0.380 |
| Total | 100.000 | 100.0001 | 100.000 |

The fiber drinks were consumed with a separate beverage containing calcium lactate (not more than 500 mg elemental calcium per serving). The placebo was taken with a second placebo beverage matched for flavor and calories, but without calcium lactate. The test drink containing calcium lactate or corresponding placebo had the following composition:

| | Calcium Placebo | Calcium Free Placebo |
|---|---|---|
| Ingredient | % | % |
| Water | 96.430 | 99.846 |
| Calcium lactate | 3.065 | 0.000 |
| Malic acid | 0.330 | 0.330 |
| Sucralose | 0.050 | 0.020 |
| Yellow #5, 1% solution | 0.007 | 0.007 |
| Red #40, 1% Solution | 0.0069 | 0.0069 |
| Flavor | 0.110 | 0.110 |
| Total | 100.000 | 100.000 |

### Test Sessions and Experimental Measurements

Test sessions occurred on the first and seventh day of the use of each experimental period. The night before the sessions, subjects consumed an evening meal of their own choosing that was replicated the night before each test session. Test sessions began between 7:00 and 9:00 AM. Subjects first completed a short questionnaire to ensure they consumed the evening meal, and had not been ill in the previous week. Immediately before a standardized breakfast meal (choice of bagel or raisin bran cereal) they were asked to consume a fiber test beverage within a three minute interval, which included the first part of the test beverage (fiber or placebo) first, immediately followed by the second part of the test beverage (calcium or placebo). They were then served the standard breakfast. They returned to the lab for lunch 4-5 hours later, and dinner 9-10 hours later. They were provided with a portable cooler containing the test beverage (fiber or placebo beverage), and the calcium beverage or calcium-free placebo beverage), and a bottle of water. They were instructed to consume the test beverage 2½ hours after the completion of lunch and not to consume any food during the day except the test meals provided, the test beverages, and the bottled water.

At the test sessions, lunch and dinner were provided as buffet-style meals. Subjects were also provided snacks for consumption during the evening. They were told to consume as much of the snacks as they desired. Lunch and dinner servings of each individual food were weighed to the nearest 0.1 g before and after consumption to determine caloric and macronutrient intake. Evening snacks were returned to the test site to determine food consumption.

Subjects were asked to consume 14 test drinks during each week of the three week-long experimental periods. On Day 1, as mentioned above, they drank one two-part test beverage before breakfast and one 2.5 hours after lunch. Additionally, on the first test day they were provided with five refrigerated test beverages (5 first part and 5 second part) to take home. They were instructed to consume one test beverage, which is one first part followed by one second part, before breakfast, and another test beverage about 2½ hours after lunch each day on the second through sixth days. Subjects returned to the laboratory on the seventh day to repeat the procedure of the first day.

### Data Analysis

Data were analyzed using the Statistical Analysis System (SAS Version 8.2, Cary, N.C.). The mixed model procedure is used to test for treatment differences, with treatment condition (low fiber, high fiber, and placebo), day (1 or 7) and the interaction of treatment condition and day entered into the statistical models. The effects of treatment session was also tested as a covariate and kept in the final model when found to be significant. The endpoint measurements included the total daily energy and macronutrient content of foods consumed, as well as at each individual meal (breakfast, lunch, dinner, and evening snack). Scores of the TFEQ were entered as covariates into a mixed model analysis of variance model as main effects and in interaction terms to determine if baseline characteristics of the subjects affected the response on food intake produced by beverage consumption. The covariates were tested as continuous and binary variables (using a fiftieth percentile cut point). For binary-coded variates, significant interactions between condition and covariate were further examined using the SLICE command in SAS to test for an effect of condition at level of the covariate.

For the total test population, consumption of the two different fiber containing beverages (1 g and 2.8 g per serving) resulted in a trend toward reduction in total calorie intake (in comparison to placebo) measured over the 24 hour period beginning with the morning beverage.

Effect of Fiber Beverages on Total Calorie

| | | Standard | P value vs. |
|---|---|---|---|
| Condition | Mean Kcal Intake | Error | placebo |
| Placebo | 2634 | 109 | 0.17 |
| 1 g fiber beverage | 2512 | 110 | 0.17 |
| 2.8 g fiber beverage | 2510 | 109 | |

Consumption of both the fiber containing beverages (1 g and 2.8 g per serving) resulted in a significant decrease in food consumption at dinner, as shown below.

Effect of Fiber Beverages on Caloric Intake at Dinner

| | | Standard | P value vs. |
|---|---|---|---|
| Condition | Mean Kcal Intake | Error | placebo |
| Placebo | 765 | 37 | |
| 1 g fiber beverage | 689 | 37 | 0.039 |
| 2.8 g fiber beverage | 678 | 37 | 0.016 |

The 1 g fiber beverage reduced dinner food intake by an average of 76 kcal, and the 2.8 g beverage provided a reduction of 87 kcal. The P values, determined by a post-hoc Tukey's analysis, indicated that these results were statistically significant (p<0.05).

Further analysis of the nutrient composition of the individual foods consumed indicated that the consumption of the fiber beverages was associated with a significant reduction in the intake of carbohydrates at dinner, as shown below.

Effect of Fiber Beverages on Carbohydrate
Caloric Intake at Dinner

| | Mean Carbohydrate | Standard | P value vs. |
|---|---|---|---|
| Condition | Kcal Intake | Error | placebo |
| Placebo | 379 | 21 | |
| 1 g fiber beverage | 329 | 21 | 0.007 |
| 2.8 g fiber beverage | 324 | 21 | 0.003 |

The 1 g beverage reduced carbohydrate intake at dinner by 50 kcal, and the 2.8 g beverage provided a 55 kcal reduction. The reduction in carbohydrate intake at both levels was statistically significant (p<0.01).

The fiber beverages also reduced total daily food intake, as shown below.

Effects of Fiber Beverages on Daily Caloric Intake

| | | Standard | P value vs. |
|---|---|---|---|
| Condition | Mean Kcal Intake | Error | placebo |
| Placebo | 1353 | 64 | |
| 1 g fiber beverage | 1261 | 64 | 0.026 |
| 2.8 g fiber beverage | 1264 | 64 | 0.033 |

The 1 g fiber beverage reduced overall food intake on the test day by an average of 92 kcal, and the 2.8 g beverage provided a reduction of 89 kcal. The P values, determined by a post-hoc Tukey's analysis, indicated that these results were statistically significant (p<0.05). These results indicated the absence of compensatory eating that could have occurred in response to the reduced dinner caloric intake.

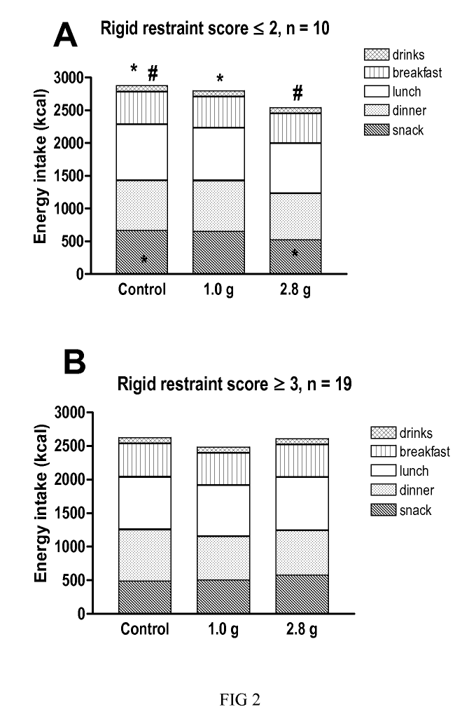

FIG. 2 presents a bar graph of energy intake (in kilocalories) over 24 hours for the groups receiving high-dose (2.8 g alginate beverage), low-dose (1.0 g alginate beverage), and placebo (beverage without alginate); “*” indicates a trend for difference between means for total daily intake and intake at evening snack (0.05>adjusted P<0.10, and “#” indicates significant difference between means for total daily intake (adjusted P=0.013). Panel A presents data for subjects with a rigid restraint score of 2 or less on the TFEQ, and Panel B presents data for subjects with a rigid restraint score of 3 or greater. Within each individual bar, the caloric intakes from breakfast, lunch, dinner, snack, and the beverages themselves are indicated. In the group with rigid restraint scores of 2 or less, significant main effects for treatment were found for total daily energy intake (P=0.013) and intake at evening snack (P=0.046). In contrast, no significant effects of treatment were noted for subjects with a rigid restraint score of 3 or greater (see Panel B).

### Example 2

A group of overweight or obese women having a BMI of 25-35 and aged 20 to 40 years of age is selected via newspaper advertisements. The women are supplied with a case containing 24 bottles of the 2.8 g alginate fiber composition of Example 1, and a second case containing 24 bottles of the 0.5 g calcium beverage composition of Example 1.

Each woman also receives a sealed envelope containing the TFEQ for determining her eating restraint status. Each woman completes the questionnaire in her home, and mails it back to the study director. Each woman consumes one bottle of the alginate fiber beverage and one bottle of the calcium beverage with breakfast, and a second pair of beverages at mid-afternoon, between lunch and dinner. These beverages are consumed using this protocol for 12 consecutive days.

Each woman also maintains a daily food diary that records all foods consumed, and the amount of each food consumed. At the end of 12 days, the women return any unused containers of beverage and the food diary to the study director. The eating restraint score of each subject is noted based on the TFEQ and the daily caloric intake for each subject are determined from the food diaries. Women with eating restraint scores of two or less (low rigid [FLEXIBLE??] restraint) are found to have consumed fewer calories during the 14 day study, in comparison to the subjects with eating restraint scores three or greater.

### Example 3

An internet website for a food intake control product includes the questions of the TFEQ. A potential purchaser enters the website, and answers the questions. A computer program records the responses to the questions, and based on the responses, calculates the rigid restraint score for the individual. Based on the obtained calculation, a new screen appears indicating the score of the potential purchaser, and if the score is two or less, a recommendation is provided that the potential purchaser purchase and use a particular product to assist in food intake control efforts. Additional computer screens linked to this screen via menu choices provide opportunities to purchase the product on-line, or alternately provide suggestions about retail locations at which the product may be purchased.

### Example 4

A health club administers the TFEQ to some or all of its members. The results of questionnaire determines the Rigid Restraint for each member answering the TFEQ. Individuals with low rigid restraint are assigned to paired or group workout sessions.

### Example 5

A health club provides new members with the TFEQ. The questionnaire is used to determine rigid restraint. Individuals with low rigid restraint are encouraged to add a personal trainer to their program.

### Example 6

A health club provides new members with the TFEQ. The questionnaire is used to determine rigid restraint. Individuals with low rigid restraint are provided reminders by automated e-mail, voice mail, text messaging, or automated voice messaging of there exercise sessions.

### Example 7

An internet website comprises the questions of the TFEQ. An individual enters the website, and answers the questions. A computer program records the responses to the questions, and based on the responses, calculates the rigid restraint score for the individual. The individual is provided with the score.

On the label of a prepared food product is listed the amount of satiety that will be induced by the product for each of the potential rigid restraint scores.

### Example 8

Scores provided in Example 8 are high or low rigid restraint. They are communicated to the individual as Eating Type 1 and Type 2.

### Example 9

A whole grain nutrition bar contains about 100 kcals of energy. The label indicates that for people of Eating Type 1 the product will offset 120 kcals of future food intake and that for Eating Type 2, the product will offset 80 kcals of future food intake.

### Example 10

Scores provided in Example 8 are Eating Type A thru E

### Example 11

A liquid meal replacement product contains 200 calories. It's label contains a graph which contains on one axis a Eating Type Scale A thru E and on the other scale the amount of future food calories that will be offset thru the satiety induced by the meal replacement.

### Example 12

A persons' health care provider allows access to an internet website that includes the questions of the TFEQ. An individual enters the website, and answers the questions. A computer program records the responses to the questions, and based on the responses, calculates the rigid restraint score for the individual. The individual is provided with the score.

On the label of a prepared food product is listed the net calories, which are the calories contained in the product les the calories that will be offset in future meals due to the satiety induced contained in the product for each of the potential scores.

The scope of the present invention is not limited by the description, examples, and suggested uses herein and modifications can be made without departing from the spirit of the invention. Thus, it is intended that the present invention cover modifications and variations of this invention provided that they come within the scope of the appended claims and their equivalents. Unless otherwise defined, all technical and scientific terms used herein have the same meaning as commonly understood by one of ordinary skill in the art to which this invention pertains. All publications, patent applications, patents, and other references mentioned herein are incorporated reference in their entirety. In case of conflict, the present specification, including definitions, will control.

What is claimed is:

1. A method for reducing food intake in an individual, the method comprising:
(a) determining the eating restraint behavior of the individual, and
(b) providing a food intake control program or a weight loss program that is effective for the determined eating restraint behavior.

2. The method of claim 1, wherein the TFEQ is used to determine eating restraint behavior.

3. The method of claim 2, wherein the individual is determined to be low rigid restraint.

4. The method of claim 3, wherein the low rigid restraint individual is provided with a food intake control program or a weight loss program comprising a composition having an effective amount of a combination of at least one soluble anionic fiber and at least one multivalent cation.

5. The method of claim 4, wherein the soluble anionic fiber is selected from the group consisting of alginate, pectin, gellan, soluble fibers containing carboxylate substituents, carrageenan, polygeenan, and marine algae-derived polymers that contain sulfate substituents and mixtures thereof, and the multivalent cation is selected from the group consisting of calcium, magnesium, aluminum, manganese, iron, nickel, copper, zinc, strontium, barium, bismuth, chromium, vanadium, lanthanum, their salts and mixtures thereof.

6. The method of claim 5, wherein the composition comprises a first beverage having the soluble anionic fiber and a second beverage having the multivalent cation.

7. The method of claim 6, wherein the soluble fiber in the first beverage comprises alginate and the multivalent cation in the second beverage comprises calcium.

8. A method of claim 7, wherein the first beverage contains about 2.8 grams of alginate per 8 oz serving, and the second beverage contains about 0.5 grams of calcium per 8 oz serving.

9. A method for reducing food intake in an individual, the method comprising:
(a) selecting an individual in need of food intake reduction or weight reduction,
(b) administering an instrument to the individual to measure the eating restraint behavior,
(c) interpreting the results obtained using the instrument to determine the eating restraint behavior of the individual, and
(d) providing a food intake control program that is effective for the determined eating restraint behavior.

10. The method of claim 9, wherein the instrument is the TFEQ.

11. The method of claim 10, wherein the individual is determined to have a rigid restraint score of less than or equal to two.

12. The method of claim 11, wherein the individual with a rigid restraint score of less than or equal to two is provided with a food intake control program or weight loss program comprising a source of alginic acid and a source of a multivalent cation.

13. The method of claims 12, wherein the source of alginic acid provides about 2.8 grams of alginic acid per 8 oz serving, and the source of calcium provides about 0.5 gram of calcium per 8 oz serving.

14. The method of claim 13, wherein the about 2.8 gram per 8 oz serving of alginic acid is provided in a first beverage, and the about 0.5 gram per 8 oz serving of calcium is provided in a second beverage.

15. The method of claim 14, wherein one alginate beverage and one calcium beverage are consumed at about the time of breakfast, and a second alginate beverage and second calcium beverage are consumed at the time about midway between lunch and dinner.

16. The method of claim 10, wherein the instrument is provided as a portion of the product label, affixed to a product, or provided in proximity to the product at the point of sale of the product.

17. The method of claim 16, wherein the instrument is administered to the individual at a point of sale, and the individual determines his or her eating restraint behavior at a point of sale.

18. The method of claim 17, wherein the individual receives a recommendation to purchase and use a product if his or her rigid restraint score is less than or equal to two.

19. A method to facilitate weight loss in an individual with low rigid restraint, the method comprising providing a food intake control program that is effective in a person with low rigid restraint.

20. The method of claim 19, wherein the individual has a rigid restraint score of two or less on the TFEQ.

21. The method of claim 20, wherein the food intake control program comprises consumption of an effective amount of alginic acid and a multivalent cation.

22. The method of claim 21, where the multivalent cation comprises calcium.

23. A method of self-diagnosing an individual's own eating restraint behavior as part of the individual's product purchase decision process, the method comprising
providing a form of the TFEQ as part of the product's label;
providing an answer key for the TFEQ on the product's label or near the product on the shelf to determine the individual's own eating restraint behavior.

24. The method of claim 23, further comprising providing indicia on the product as to the type of eating restraint behavior the product most benefits in terms of decreasing caloric intake or reducing weight.
